(19) United States
(12) Patent Application Publication
(10) Pub. No.: US 2025/0232906 A1
(43) Pub. Date: Jul. 17, 2025

(54) THREE-PHASE THREE-LEGGED WOUND CORE AND METHOD FOR PRODUCTION THEREOF

(71) Applicant: JFE Steel Corporation, Chiyoda-ku, Tokyo (JP)

(72) Inventors: Hirotaka INOUE, Chiyoda-ku, Tokyo (JP); Takeshi OMURA, Chiyoda-ku, Tokyo (JP); Kenki SHIMIZU, Chiyoda-ku, Tokyo (JP)

(73) Assignee: JFE Steel Corporation, Chiyoda-ku, Tokyo (JP)

(21) Appl. No.: 18/838,735

(22) PCT Filed: Feb. 17, 2023
(86) PCT No.: PCT/JP2023/005716

§ 371 Date: Aug. 15, 2024

(30) Foreign Application Priority Data
Mar. 3, 2022 (JP) 2022-032471

(51) Int. Cl. H01F 27/245; H01F 41/02

(52) U.S. Cl. CPC H01F 27/245; H01F 41/0233

(57) ABSTRACT

A three-phase three-legged wound core is disclosed. The three-phase three-legged wound core includes two adjacent inner cores and one outer core enclosing the two inner cores, the inner cores and the outer core including a grain-oriented electrical steel sheet. In the three-phase three-legged wound core, the two inner cores and the one outer core each have a flat section, a corner section adjacent to the flat section, a lap zone in the flat section, and a bent portion in the corner section; the corner sections of the two inner cores and of the one outer core are each provided with two bent portions, the angle formed by the two bent portions being 55° or less; and the grain-oriented electrical steel sheet has a magnetic flux density B8 of 1.92 T or more and 1.98 T or less at a magnetic field strength H of 800 A/m.

### CROSS REFERENCE TO RELATED APPLICATIONS

This is the U.S. National Phase application of PCT/JP2023/005716, filed Feb. 17, 2023 which claims priority to Japanese Patent Application No. 2022-032471, filed Mar. 3, 2022, the disclosures of these applications being incorporated herein by reference in their entireties for all purposes.

### FIELD OF THE INVENTION

The present invention relates to a three-phase three-legged wound core and a method for producing the same, more particularly, to a three-phase three-legged wound transformer core produced from a grain-oriented electrical steel sheet as a material and to a method for producing the same.

### BACKGROUND OF THE INVENTION

Grain-oriented electrical steel sheets with a crystal structure in which <001> orientation, an axis of easy magnetization of iron, is highly aligned in the rolling direction of the steel sheet are used particularly as iron core materials for power transformers. Depending on the iron core structures, transformers are broadly divided into stacked core transformers and wound core transformers. In a stacked core transformer, steel sheets cut to a predetermined shape are stacked to form an iron core. On the other hand, an iron core in a wound core transformer is formed by winding a steel sheet. In particular, aspects of the present invention deal with a so-called Evans-type three-phase three-legged wound core in which two adjacent inner cores are enclosed in one outer core, as illustrated in FIG. 1.

While requirements for transformer cores range widely, low iron loss is particularly important. From this point of view, low iron loss is an important requirement of grain-oriented electrical steel sheets that are iron core materials. High magnetic flux density is also necessary in order to lower the excitation current in a transformer and to reduce the copper loss. The magnetic flux density is evaluated as the magnetic flux density B8 (T) at a magnetizing force of 800 A/m, and the B8 is generally greater with increasing degree of accumulation in Goss orientation. An electrical steel sheet with a high magnetic flux density generally has a small hysteresis loss and is excellent in iron loss characteristics. In order to reduce iron loss, it is important that the crystal orientation of secondary recrystallized grains in steel sheets be highly aligned with the Goss orientation and that impurities in the steel composition be reduced.

Unfortunately, there are limits in controlling the crystal orientation and in reduction of impurities. Thus, a magnetic domain refining technique has been developed. In this technique, nonuniformity is physically introduced to the surface of a steel sheet and the width of magnetic domains is subdivided to reduce the iron loss. For example, Patent Literature 1 and Patent Literature 2 describe heat-resistant magnetic domain refining methods in which linear grooves with a predetermined depth are formed on the surface of a steel sheet. In Patent Literature 1, the grooves are formed with a gear roller. In Patent Literature 2, the linear grooves are formed on the surface of a steel sheet by etching. These techniques are advantageously applicable to wound cores and the like because the magnetic domain refining effects applied to the steel sheet are not lost even when the steel sheet is heat-treated, for example, strain-relief annealed at the time of wound core production.

In order to reduce the transformer iron loss, it is generally considered that the iron loss (material iron loss) of a grain-oriented electrical steel sheet as an iron core material should be reduced. On the other hand, the iron loss in a transformer is frequently higher than the material iron loss. The value of iron loss (transformer iron loss) in a transformer using an electrical steel sheet as an iron core, divided by the iron loss of the material obtained by, for example, the Epstein test is generally called the building factor (BF) or the destruction factor (DF). That is, the BF in a transformer typically exceeds 1. The lowering of BF will lead to a lower transformer iron loss.

As generally known, some factors (BF factors) have been pointed out as responsible for the increase in transformer iron loss in an Evans-type three-phase three-legged wound core over the material iron loss. Such factors are, for example, the occurrence of magnetic flux concentration at an inner core due to the difference in magnetic path length; the local distortion of magnetic flux waveform in an iron core stemming from three-phase excitation; the occurrence of in-plane eddy-current loss at a steel sheet joint; and an increase in iron loss due to strains introduced by working.

The increase in iron loss that is caused by the magnetic flux concentration on the inner side of an iron core due to the difference in magnetic path length will be discussed. In an Evans-type three-phase three-legged wound core, the magnetic flux is concentrated at an inner core because the magnetic path of the inner core is shorter than the magnetic path of the outer core. In general, the iron loss of a magnetic material increases rapidly in a nonlinear manner versus the increase in excitation magnetic flux density as the saturation magnetization is approached. Furthermore, when the magnetic flux is concentrated at an inner core, the magnetization is saturated and the magnetic flux waveform is distorted to cause a further increase in iron loss. Thus, the magnetic flux concentrated at an inner core gives rise to a specific increase in iron loss on the inner side of the iron core, resulting in an increase in iron loss of the whole iron core.

The occurrence of local distortion of magnetic flux waveform in an iron core stemming from three-phase excitation will be discussed. FIG. 2 is a sectional view of flows of magnetic flux at a specific phase moment in a three-phase three-legged wound core (a transformer). At this moment, the left leg and the middle leg are magnetized in opposite directions and the magnetization in the right leg is 0. As illustrated, the magnetic flux (i) flows in the inner core between the left leg and the middle leg. As illustrated, some of the magnetic flux flowing through the outer core is transferred to the inner core and flows as the magnetic flux (ii) through the middle leg, and is transferred again from the inner core to the outer core. The rest of the magnetic flux (iii) that has not been transferred flows through the right leg as illustrated. Although the magnetic flux excitation by a winding wire is zero at the moment illustrated in FIG. 2, the magnetic flux is locally more than zero because the magnetic flux (iii) flows into the right leg. As a result, the magnetic flux waveform in the iron core is distorted compared to the sine wave. Thus, the iron loss is increased locally.

The generation of in-plane eddy-current loss at a steel sheet joint will be discussed. In general, a transformer wound core has a cut portion for inserting a winding wire. After a winding wire is inserted into the iron core through the cut portion, the steel sheets are joined together while providing lap zones. As illustrated in FIG. 3, the portions at the steel sheet joints where the steel sheets lap (the lap zones) allow the magnetic flux to transfer to the adjacent steel sheet in the direction perpendicular to the surface, thus generating an in-plane eddy current. As a result, the iron loss is increased locally.

Strains introduced by working are a factor that increases the iron loss. Strains introduced by working, such as slitting of steel sheets and bending at the time of iron core production, impair magnetic properties of the steel sheets and increase the iron loss. Incidentally, a wound core is typically annealed at a temperature above the strain relief temperature after production. This annealing is generally called strain relief annealing.

In consideration of the above factors that increase the transformer iron loss, for example, the following measures have been suggested to reduce the transformer iron loss.

Patent Literature 3 discloses an iron core in which the inner peripheral side with a short magnetic path length is constructed by an electrical steel sheet with lower magnetic properties than the outer peripheral side, and the outer peripheral side with a long magnetic path length is constructed by an electrical steel sheet with higher magnetic properties than the inner peripheral side. The disclosure states that the above configuration avoids magnetic flux concentration on the inner peripheral side of the iron core and effectively reduces the transformer iron loss. Furthermore, Patent Literature 3 discloses a three-phase three-legged wound core in which inner cores and an outer core are each made of materials with different magnetic properties, and the materials are arranged on the inner peripheral side and the outer peripheral side so that the magnetic flux on the inner peripheral side will be concentrated. The disclosure states that the above configuration effectively reduces the transformer iron loss.

### PATENT LITERATURE

PTL 1: Japanese Examined Patent Application Publication No. 62-53579
PTL 2: Japanese Patent No. 2895670
PTL 3: Japanese Patent No. 5286292

### SUMMARY OF THE INVENTION

As disclosed in Patent Literature 3, the transformer characteristics can be efficiently improved by using different materials on the inner peripheral side and the outer peripheral side so as to avoid magnetic flux concentration on the inner peripheral side. However, this approach entails appropriate arrangement of two kinds of materials (steels) with different magnetic properties (iron loss), thus making the transformer design very complicate and significantly deteriorating the productivity.

An object of aspects of the present invention is to provide a three-phase three-legged wound core that attains excellent magnetic properties with low transformer iron loss without using two or more kinds of materials having different magnetic properties.

In order to produce a three-phase three-legged wound core having excellent magnetic properties with low transformer iron loss, the iron core should be designed so as to reduce the magnetic flux concentration at the inner core stemming from the difference in magnetic path length and the iron core material should be selected so that the magnetic flux waveform will not be distorted and the increase in iron loss will be small even when the magnetic flux is concentrated at the inner core. Furthermore, it is also necessary to suppress the local distortion of magnetic flux waveform in the iron core stemming from three-phase excitation.

The iron core design for reducing the magnetic flux concentration requires the following two points:
(1) The wound core has flat sections and corner sections adjacent to the flat sections; the flat sections have lap zones; and the corner sections have bent portions.
(2) The iron core material (the grain-oriented electrical steel sheet) has a magnetic flux density B8 of 1.92 T or more and 1.98 T or less at a magnetic field strength H of 800 A/m.

To suppress the occurrence of local distortion of magnetic flux waveform in an iron core stemming from three-phase excitation, the following design is needed.
(3) Corner sections (corner sections of each of two inner cores and one outer core) each have two bent portions, and the angle formed by the two bent portions is 55° or less.

To realize a small increase in iron loss even when the magnetic flux waveform is distorted, the iron core material that is selected preferably satisfies the following:
(4) The iron loss deterioration rate under harmonic superposition is 1.35 or less as calculated from the following formula:
iron loss deterioration rate under harmonic superposition=(iron loss under harmonic superposition)/(iron loss without harmonic superposition).

In the above formula, the iron loss under harmonic superposition and the iron loss without harmonic superposition are the iron loss (W/kg) each measured under the condition of a frequency of 50 Hz and a maximum magnetization of 1.7 T, and the iron loss under harmonic superposition is the iron loss measured under conditions where the superposition ratio of third harmonic to fundamental harmonic at an excitation voltage is 40% and the phase difference is 60°.

These requirements and the reasons why these conditions are required will be described in detail below.
(1) The wound core has flat sections and corner sections adjacent to the flat sections; the flat sections have lap zones; and the corner sections have bent portions.

The wound core is produced by winding a magnetic material, such as a grain-oriented electrical steel sheet. In a typical method for wound core production, a steel sheet is wound into a cylindrical shape and is pressed into a rectangular shape so that corner sections will have a predetermined curvature. In an alternative production method, portions that will be corner sections of a wound core are bent beforehand, and the bent steel sheets are stacked to form a wound core. An iron core formed by this method has bends (bent portions) at the corner sections. Iron cores formed by the former method are generally called tranco-cores, and iron cores formed by the latter method are generally referred to as unicores or duocores depending on the number of steel sheet joints provided. The latter method that forms bends (bent portions) at corner sections is suited for reducing the magnetic flux concentration.

The results of experimental investigation of the magnetic flux concentration and the magnetic flux density waveform in tranco-cores and unicores are discussed below. One tranco-core and two unicores of three-phase three-legged type, having the shapes illustrated in FIG. 4, were formed by winding a 0.23 mm thick grain-oriented electrical steel sheet (magnetic flux density B8: 1.94 T, W15/60:0.77 W/kg). The tranco-core and one of the unicores were annealed under the same conditions to relieve strain. A winding wire was wound around the core 50 times, and no-load excitation was performed at a magnetic flux density of 1.5 T and a frequency of 60 Hz. Single-turn search coils were arranged at the positions illustrated in FIG. 5 to study the magnetic flux density distribution in the iron core. FIG. 6 shows the maximum values of magnetic flux density at intervals of ½ thickness of the respective iron cores from the inner peripheral side of the inner core to the outer peripheral side of the outer core. All the tranco-core (with strain relief annealing) and the unicores (with strain relief annealing and without strain relief annealing) had a higher magnetic flux density on the inner peripheral side and the magnetic flux was concentrated at the inner core. FIG. 7 illustrates the results of evaluating the form factor of the magnetic flux waveform differentiated with respect to time (dB/dt). The comparison of the tranco-core with the unicores shows that the magnetic flux concentration is smaller and the form factor is lower in the unicores, that is, the distortion of magnetic flux waveform is better suppressed in the unicores.

The distortion of magnetic flux waveform is suppressed by the unicore design, specifically, by providing bent portions at corner sections of an iron core, probably for the following reason. Deformation twins and the like remain in bent portions of corner sections of a unicore even when strain relief annealing is performed, and the magnetic permeability is locally reduced compared to other portions. Such portions with extremely low magnetic permeability do not allow the passage of magnetic flux above a certain level. As a result, the magnetic flux will not be concentrated exclusively on the inner side of the iron core even in the presence of a difference in magnetic path length. When magnetic flux concentration occurs, the magnetic flux is saturated at a portion where the magnetic flux density is maximum. Thus, as illustrated in FIG. 8, the waveform is distorted into trapezoidal. That is, the form factor of the waveform differentiated with respect to time (dB/dt) is increased. In the inner coils of the unicores, magnetic flux concentration was unlikely to occur as compared to the tranco-core that had no bent portions with low magnetic permeability. This is probably the reason why the distortion of magnetic flux waveform was smaller.

Aspects of the present invention are directed to a three-phase three-legged wound core having bent portions at corner sections. For example, the wound core is composed of two adjacent inner cores and one outer core enclosing the two inner cores, similarly to the unicore illustrated in FIG. 4. The requirement (1) is satisfied by providing the two inner cores and the one outer core with flat sections and corner sections adjacent to the flat sections, providing the flat sections with lap zones, and providing the corner sections with bends (bent portions).
(2) The iron core material (the grain-oriented electrical steel sheet) has a magnetic flux density B8 of 1.92 T or more and 1.98 T or less at a magnetic field strength H of 800 A/m.

The results of experimental investigation of the influences of the magnetic flux density B8 on the distortion of magnetic flux waveform in a unicore will be discussed. Three-phase three-legged unicores (two inner cores and one outer core) having the shape illustrated in FIG. 4 were produced using 0.23 mm thick grain-oriented electrical steel sheets with different magnetic flux densities B8 described in Table 1. A winding wire was wound around the unicores 50 times, and no-load excitation was performed at a magnetic flux density of 1.5 T and a frequency of 60 Hz. Single-turn search coils were arranged at the positions illustrated in FIG. 5 to study the magnetic flux density waveform in the iron core, and the magnetic flux waveform was differentiated with respect to time (dB/dt) to evaluate the form factor. FIG. 9 shows the form factors of the magnetic flux waveforms of the inner halves (location (i)) of the inner cores of the respective materials, differentiated with respect to time (dB/dt). The form factor tended to decrease with increasing magnetic flux density B8 but increased again when the magnetic flux density was more than 1.98 T. Magnetic flux densities of 1.92 T and more and 1.98 T and less are a preferred range that allows for small distortion of magnetic flux waveform.

The magnetic flux concentration at the inner core is relaxed with increasing magnetic flux density B8 of the grain-oriented electrical steel sheet as the material forming the iron core. The reason behind this is probably as follows. An iron core material having a high magnetic flux density B8 is generally slow in reaching magnetic flux saturation. Even when the magnetic flux is concentrated on the inner side of an iron core due to the difference in magnetic path length, saturation does not occur until a high magnetic flux density is reached and thus the trapezoidal distortion of magnetic flux waveform will be unlikely to occur. If, on the other hand, the magnetic flux density B8 of an iron core material is too high, the highness in saturation magnetization allows the magnetic flux to be concentrated excessively in the presence of a difference in magnetic path length, thus leading to a large distortion of magnetic flux waveform. The present inventors assume that the distortion of magnetic flux waveform could be reduced to a low level in a certain range of the magnetic flux density B8.

TABLE 1

| | Magnetic flux density B8 (T) |
|---|---|
| 1 | 1.90 |
| 2 | 1.91 |
| 3 | 1.92 |
| 4 | 1.93 |
| 5 | 1.94 |
| 6 | 1.96 |
| 7 | 1.97 |
| 8 | 1.98 |
| 9 | 1.99 |

The following describes the iron core shape design and the reasons why the iron core shape is thus designed to suppress the occurrence of local distortion of magnetic flux waveform in the iron core stemming from three-phase excitation.
(3) Corner sections of each of two inner cores and one outer core each have two bent portions, and the angle formed by the two bent portions is 55° or less.

As described hereinabove, when a magnetic flux is caused to flow by three-phase excitation, part of the magnetic flux flows into the leg with zero excitation (the right leg in FIG. 2) to give rise to local distortion of magnetic flux waveform. In order to suppress this, it is important that more magnetic flux be transferred between the inner core and the outer core. The present inventors have conceived that the magnetic flux transferring between the inner core and the outer core could be controlled by controlling the size of the triangular window formed in the gap between the inner cores and the outer core of the unicore illustrated in FIG. 10.

FIG. 11 schematically illustrates flows of magnetic flux at a specific phase moment in the three-phase three-legged wound cores (transformers) illustrated in FIG. 2, around the triangular window. Part of the magnetic flux flowing through the outer core is transferred to the inner core so that the magnetic path length is shortened, and then flows through the middle leg. This flux is the magnetic flux transferring between the inner core and the outer core. The magnetic flux that will be transferred from the outer core to the inner core is obliged to flow aside the triangular window. When the triangular window is large, the magnetic path length is increased by the increment in size as compared to when the triangular window is small. Because the magnetic flux transferring between the inner core and the outer core is generated due to the short magnetic path length, the transfer is inhibited when the triangular window is large. The present inventors have conceived that when, in contrast, the triangular window is small, more magnetic flux will be allowed to transfer between the inner core and the outer core and consequently the local distortion of magnetic flux waveform will be reduced.

The above hypothesis was verified by experiments as described below. As illustrated in FIG. 12, the triangular window of a unicore is larger with increasing angle formed by the two bent portions (the first bent portion and the second bent portion in FIG. 12) present at the corner section (hereinafter, this angle is also written simply as the angle formed by the bent portions). Unicores having the iron core shape illustrated in FIG. 13 were produced using a 0.23 mm thick grain-oriented electrical steel sheet (magnetic flux density B8: 1.94 T, W15/60:0.77 W/kg). As described in Table 2, these unicores differed from one another in the lengths e, f, and g in FIG. 13, the angle formed by the bent portions, and the size of the triangular window. A winding wire was wound around the unicores 50 times (the unicores were not strain-relief annealed), and no-load excitation was performed at a magnetic flux density of 1.5 T and a frequency of 60 Hz. During this process, single-turn search coils were arranged at the positions illustrated in FIG. 14, and the magnetic flux density waveform in the iron core was studied. The magnetic flux waveform was differentiated with respect to time (dB/dt) to evaluate the form factor. Furthermore, the form factors at the search coils (i) and (ii) were averaged to evaluate the local distortion of magnetic flux waveform. FIG. 15 illustrates the relationship between the iron core design and the local distortion of magnetic flux waveform (the average of the form factors at the search coils (i) and (ii)). As hypothesized, the local distortion of magnetic flux waveform decreased with decreasing angle formed by the bent portions and decreasing size of the triangular window. In particular, the results have shown that the local distortion of magnetic flux waveform can be advantageously reduced when the angle formed by the bent portions is 55° or less. The three-phase three-legged wound core according to aspects of the present invention is composed of two adjacent inner cores and one outer core enclosing the two inner cores. Furthermore, the angles formed by the bent portions at the corner sections illustrated in FIG. 12 (the bent portions at the corner sections on the middle leg side of the inner cores) are substantially equal to the angles formed by the bent portions at the other corner sections. That is, in accordance with aspects of the present invention, the corner sections of the two inner cores (four corner sections per inner core) and the corner sections (four corner sections) of the one outer core are each provided with two bent portions, and the local distortion of magnetic flux waveform can be advantageously suppressed particularly when the angle formed by the two bent portions is 55° or less.

TABLE 2

| | Steel strip | | | | | | | | | Angle formed by bent |
|---|---|---|---|---|---|---|---|---|---|---|
| | width H | a | b | c | d | e | f | g | w | portions |
| | (mm) | (mm) | (mm) | (mm) | (mm) | (mm) | (mm) | (mm) | (mm) | (deg.) |
| 1 | 110 | 75 | 145 | 285 | 235 | 2 | 10 | 18 | 45 | 20 |
| 2 | 110 | 75 | 145 | 285 | 235 | 2 | 12 | 22 | 45 | 26 |
| 3 | 110 | 75 | 145 | 285 | 235 | 2 | 13 | 24 | 45 | 28 |
| 4 | 110 | 75 | 145 | 285 | 235 | 2 | 15 | 28 | 45 | 34 |
| 5 | 110 | 75 | 145 | 285 | 235 | 3 | 16 | 29 | 45 | 34 |
| 6 | 110 | 75 | 145 | 285 | 235 | 3 | 17 | 31 | 45 | 36 |
| 7 | 110 | 75 | 145 | 285 | 235 | 3 | 19 | 35 | 45 | 42 |
| 8 | 110 | 75 | 145 | 285 | 235 | 3 | 21 | 39 | 45 | 47 |
| 9 | 110 | 75 | 145 | 285 | 235 | 3 | 23 | 43 | 45 | 53 |
| 10 | 110 | 75 | 145 | 285 | 235 | 3 | 24 | 45 | 45 | 56 |
| 11 | 110 | 75 | 145 | 285 | 235 | 3 | 25 | 47 | 45 | 59 |
| 12 | 110 | 75 | 145 | 285 | 235 | 3 | 30 | 57 | 45 | 74 |

Next, the conditions and the reasons will be described for the selection of an iron core material that has a small increase in iron loss even when a distortion of magnetic flux waveform occurs.
(4) The iron loss deterioration rate under harmonic superposition is 1.35 or less (preferred condition)

As already described, magnetic flux concentration on the inner side of an iron core distorts the magnetic flux waveform into trapezoidal and results in an increase in iron loss. The reason behind this is that when the magnetic flux waveform is trapezoidal, a sharp change occurs in the magnetic flux at a moment on a side of the trapezoid and consequently the eddy-current loss is increased. A sharp change in magnetic flux occurs similarly when the magnetic flux waveform in an iron core is locally distorted upon three-phase excitation, and consequently the eddy-current loss is increased.

In order to simulate the distortion of magnetic flux waveform and the increase in eddy-current loss, iron core materials were magnetically tested while the magnetic flux waveform was intentionally distorted by harmonic superposition. The test was performed under various harmonic superposition conditions. The results have shown that the increase in eddy-current loss in a wound core is well simulated by the iron loss measured under conditions where the superposition ratio of third harmonic to fundamental harmonic at an excitation voltage is 40% and the phase difference is 60°.

The experimental results that support the above preferred range will be discussed below. Three-phase three-legged unicores (two inner cores and one outer core) having the shape illustrated in FIG. 4 were produced using 0.23 mm thick grain-oriented electrical steel sheets A to K with different iron loss deterioration rates under harmonic superposition described in Table 3. The materials (the grain-oriented electrical steel sheets A to K) with different iron loss deterioration rates under harmonic superposition were produced by changing the coating tension of the insulating coating formed on the surface of the electrical steel sheet. The iron loss deterioration rate under harmonic superposition decreased with increasing coating tension. A winding wire was wound around the unicores 50 times, and no-load excitation was performed at a magnetic flux density of 1.5 T and a frequency of 60 Hz. The iron loss was measured. FIG. 16 illustrates the relationship between the iron loss deterioration rate under harmonic superposition and the transformer iron loss. The transformer iron loss was smaller in the region where the iron loss deterioration rate under harmonic superposition was 1.35 and less.

By selecting the iron core material based on the iron loss deterioration rate under harmonic superposition, the increase in iron loss can be better suppressed even when a distortion of magnetic flux waveform occurs.

TABLE 3

| | Iron loss (W/kg) | Iron loss (W/kg) | Iron loss deterioration |
|---|---|---|---|
| | without harmonic | under harmonic | rate under harmonic |
| | superposition | superposition*¹ | superposition*² |
| Grain-oriented electrical | 0.76 | 0.81 | 1.06 |
| steel sheet A | | | |
| Grain-oriented electrical | 0.77 | 0.83 | 1.08 |
| steel sheet B | | | |
| Grain-oriented electrical | 0.77 | 0.89 | 1.16 |
| steel sheet C | | | |
| Grain-oriented electrical | 0.80 | 0.96 | 1.20 |
| steel sheet D | | | |
| Grain-oriented electrical | 0.82 | 1.01 | 1.23 |
| steel sheet E | | | |
| Grain-oriented electrical | 0.82 | 1.06 | 1.29 |
| steel sheet F | | | |
| Grain-oriented electrical | 0.85 | 1.12 | 1.32 |
| steel sheet G | | | |
| Grain-oriented electrical | 0.87 | 1.17 | 1.34 |
| steel sheet H | | | |
| Grain-oriented electrical | 0.88 | 1.20 | 1.36 |
| steel sheet I | | | |
| Grain-oriented electrical | 0.89 | 1.26 | 1.42 |
| steel sheet J | | | |
| Grain-oriented electrical | 0.90 | 1.34 | 1.49 |
| steel sheet K | | | |

*¹Iron loss measured under conditions where the superposition ratio of third harmonic to fundamental harmonic at the excitation voltage is 40% and the phase difference is 60°.
*²Iron loss deterioration rate under harmonic superposition = (Iron loss (W/kg) under harmonic superposition)/(Iron loss (W/kg) without harmonic superposition)

Aspects of the present invention have been made based on the findings discussed above and include the following configurations.

[1] A three-phase three-legged wound core comprising two adjacent inner cores and one outer core enclosing the two inner cores, the inner cores and the outer core comprising a grain-oriented electrical steel sheet, wherein
the two inner cores and the one outer core each have a flat section, a corner section adjacent to the flat section, a lap zone in the flat section, and a bent portion in the corner section,
the corner sections of the two inner cores and of the one outer core are each provided with two bent portions, the angle formed by the two bent portions being 55° or less, and
the grain-oriented electrical steel sheet has a magnetic flux density B8 of 1.92 T or more and 1.98 T or less at a magnetic field strength H of 800 A/m.

[2] The three-phase three-legged wound core according to [1], wherein the grain-oriented electrical steel sheet has an iron loss deterioration rate under harmonic superposition of 1.35 or less as determined from the following formula:

iron loss deterioration rate under harmonic superposition=(iron loss under harmonic superposition)/(iron loss without harmonic superposition)

wherein the iron loss under harmonic superposition and the iron loss without harmonic superposition are each an iron loss (W/kg) measured at a frequency of 50 Hz and a maximum magnetization of 1.7 T, and the iron loss under harmonic superposition is an iron loss measured under conditions where the superposition ratio of third harmonic to fundamental harmonic at an excitation voltage is 40% and the phase difference is 60°.

[3] The three-phase three-legged wound core according to [1] or [2], wherein the grain-oriented electrical steel sheet has been subjected to non-heat-resistant magnetic domain refining treatment.

[4] A method for producing a three-phase three-legged wound core, the three-phase three-legged wound core being such that the three-phase three-legged wound core comprises two adjacent inner cores and one outer core enclosing the two inner cores; the inner cores and the outer core comprise a grain-oriented electrical steel sheet; and the two inner cores and the one outer core each have a flat section, a corner section adjacent to the flat section, a lap zone in the flat section, and a bent portion in the corner section, the method comprising:
providing each of the corner sections of the two inner cores and of the one outer core with two bent portions in such a manner that the angle formed by the two bent portions is 55° or less, the grain-oriented electrical steel sheet having a
magnetic flux density B8 of 1.92 T or more and 1.98 T or less at a magnetic field strength H of 800 A/m.

[5] The method for producing a three-phase three-legged wound core according to [4], wherein the grain-oriented electrical steel sheet has an iron loss deterioration rate under harmonic superposition of 1.35 or less as determined from the following formula:

iron loss deterioration rate under harmonic superposition=(iron loss under harmonic superposition)/(iron loss without harmonic superposition)
wherein the iron loss under harmonic superposition and the iron loss without harmonic superposition are each an iron loss (W/kg) measured at a frequency of 50 Hz and a maximum magnetization of 1.7 T, and the iron loss under harmonic superposition is an iron loss measured under conditions where the superposition ratio of third harmonic to fundamental harmonic at an excitation voltage is 40% and the phase difference is 60°.

[6] The method for producing a three-phase three-legged wound core according to [4] or [5], wherein the grain-oriented electrical steel sheet has been subjected to non-heat-resistant magnetic domain refining treatment.

The three-phase three-legged wound core provided according to aspects of the present invention has low transformer iron loss and excels in magnetic properties. According to aspects of the present invention, a three-phase three-legged wound core having excellent magnetic properties with low transformer iron loss can be obtained without using two or more kinds of materials having different magnetic properties (iron loss). Aspects of the present invention can reduce the complexity encountered when designing iron cores using two or more kinds of materials having different magnetic properties, for example, the arrangement of such materials, and enable high productivity of iron cores having excellent magnetic properties with low iron loss.

### BRIEF DESCRIPTION OF THE DRAWINGS

FIG. 1 is a view schematically illustrating a configuration of a three-phase three-legged wound core.

FIG. 2 is a view schematically illustrating flows of magnetic flux in a three-phase three-legged wound core (a transformer) at a specific phase moment.

FIG. 3 is a view illustrating magnetic flux transferring in lap zones in the direction perpendicular to the surface of steel sheets.

FIG. 4 is a set of views (side views) illustrating the shapes of a tranco-core and a unicore produced experimentally.

FIG. 5 is a view illustrating an arrangement of search coils in investigation of magnetic flux density distribution in an iron core.

FIG. 6 is a diagram illustrating the results of investigation of magnetic flux concentration in a tranco-core and unicores.

FIG. 7 is a diagram illustrating the results of evaluation of the form factor in a tranco-core and unicores.

FIG. 8 is a diagram illustrating waveform distortion caused by magnetic flux concentration.

FIG. 9 is a diagram illustrating the relationship between the magnetic flux density B8 of an iron core material and the form factor at ½ thickness of an inner core.

FIG. 10 is a view illustrating a triangular window formed in the gap between inner cores and an outer core of a unicore.

FIG. 11 is a set of views schematically illustrating flows of magnetic flux at a specific phase moment near a triangular window of a three-phase three-legged wound core (a transformer).

FIG. 12 is a view illustrating the relationship between the size of a triangular window of a unicore and the angles formed by two bent portions present at corner sections of inner cores.

FIG. 13 is a view (a side view) illustrating the iron core shape of an experimentally produced unicore.

FIG. 14 is a view illustrating an arrangement of search coils in evaluation of the magnetic flux transferring between the inner core and the outer core of the unicore illustrated in FIG. 13.

FIG. 15 is a diagram illustrating the relationship between the local distortion of magnetic flux waveform in the unicore evaluated with the search coils illustrated in FIG. 14, and the angle formed by the bent portions.

FIG. 16 is a diagram illustrating the relationship between the iron loss deterioration rate of an iron core material under harmonic superposition and the transformer iron loss.

FIG. 17 is a view (a side view) illustrating the shape of a tranco-core produced in Example.

FIG. 18 is a view (a side view) illustrating the shape of a unicore produced in Example.

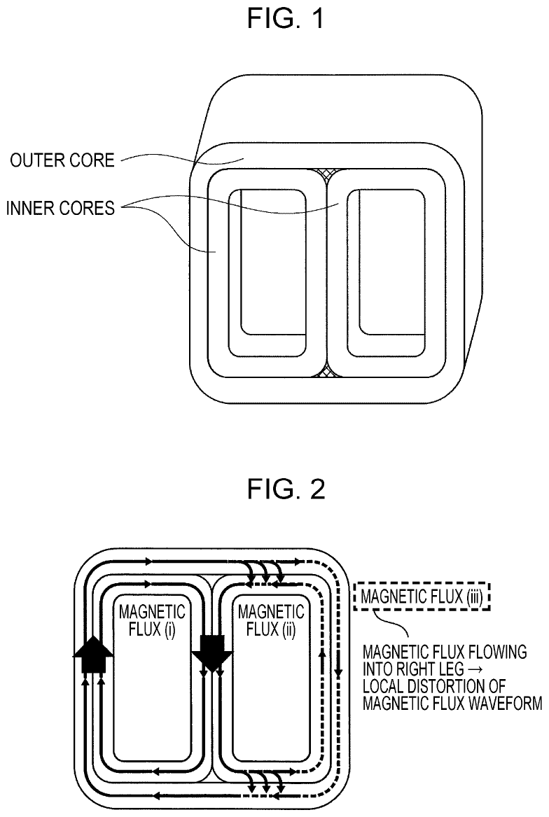

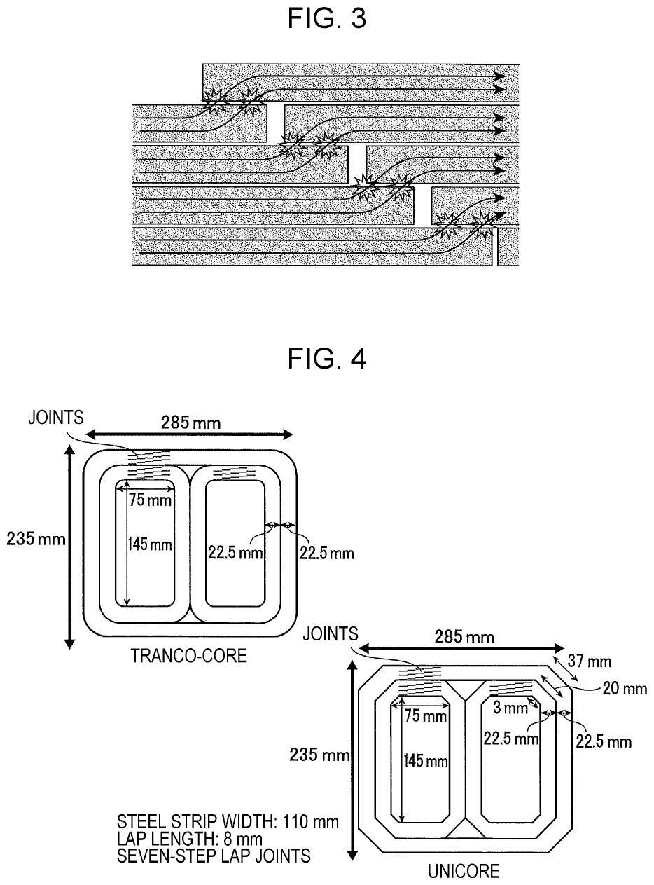

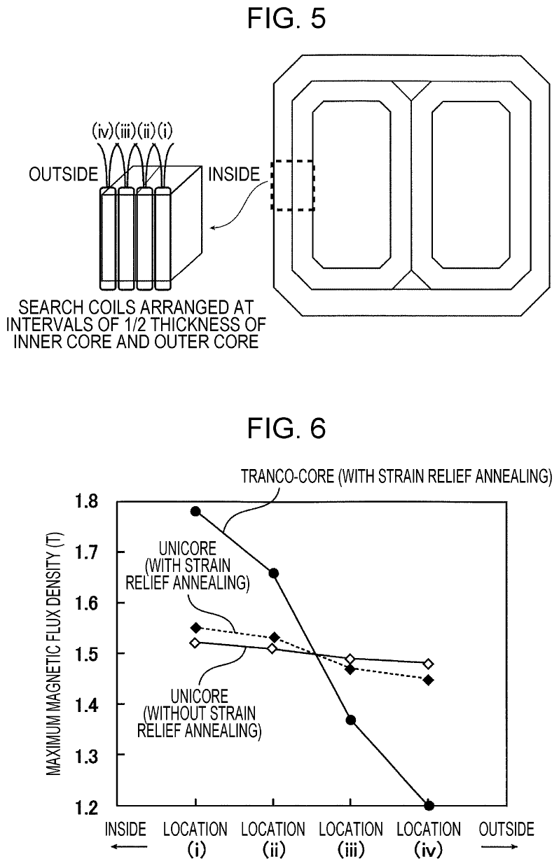

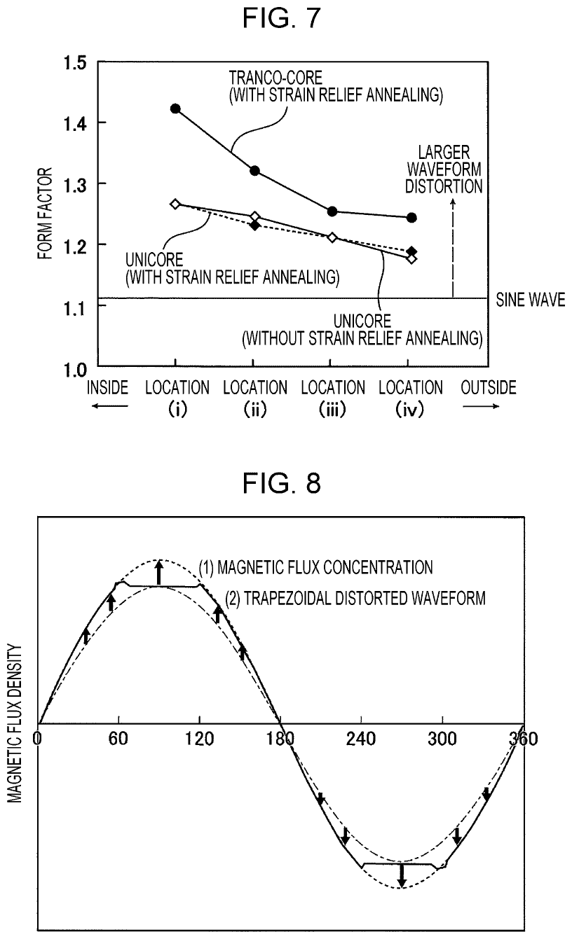

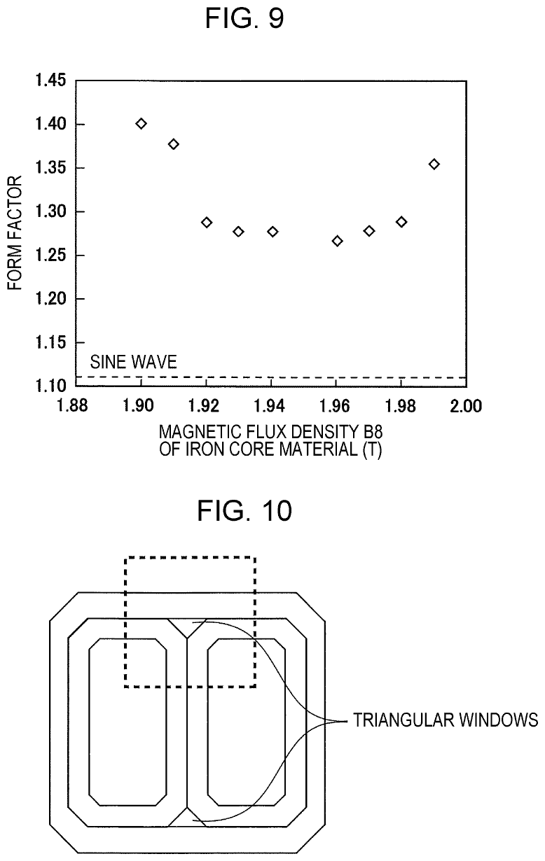

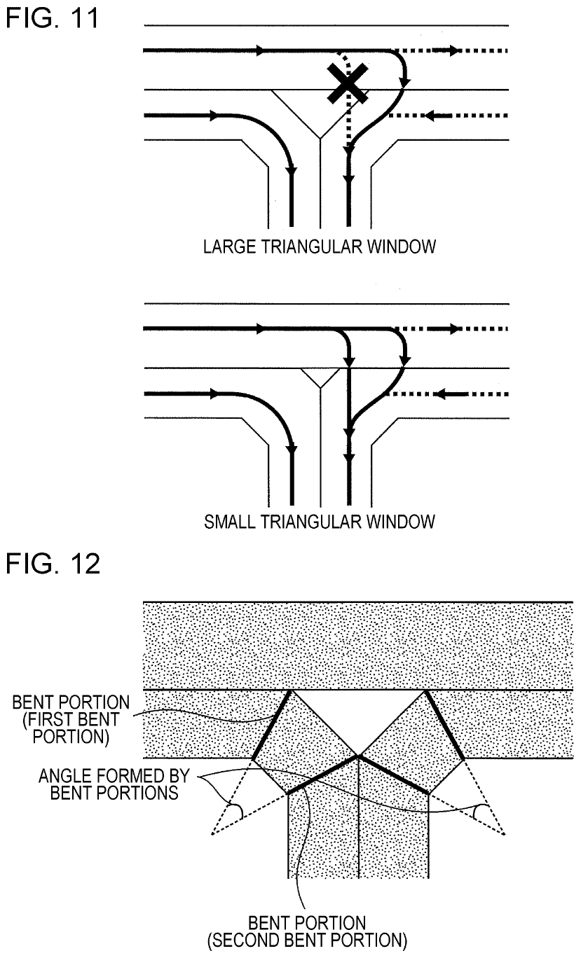

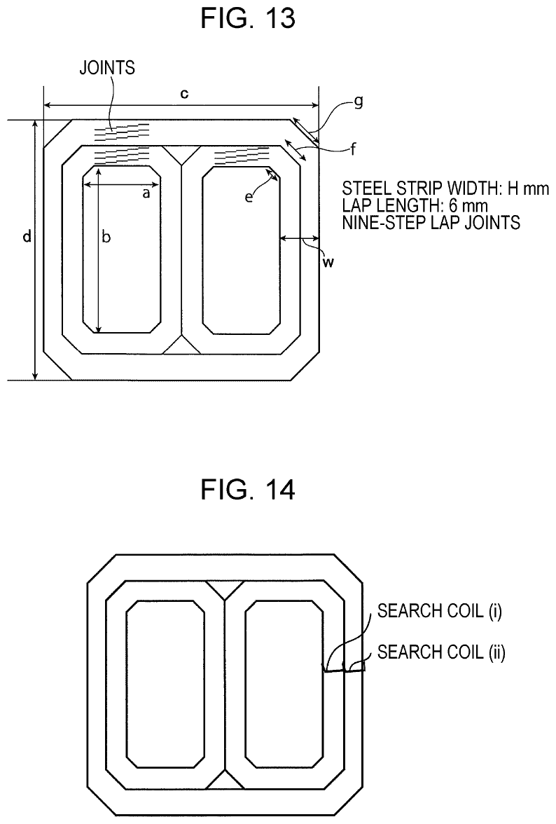

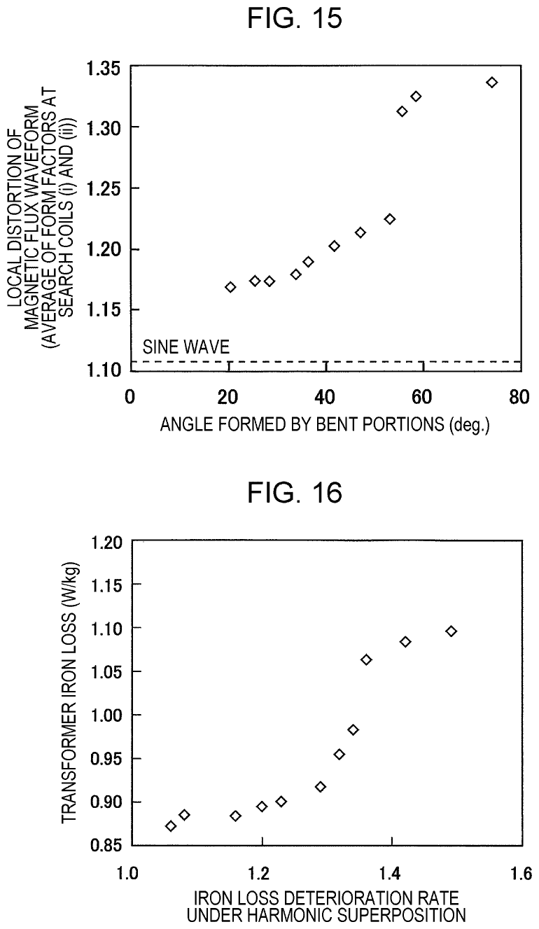

### DETAILED DESCRIPTION OF EMBODIMENTS OF THE INVENTION

Embodiments of the present invention will be described in detail below.

### <Three-Phase Three-Legged Wound Cores>

As described above, the following conditions should be satisfied in order to achieve a transformer wound core with low iron loss.
(A) The iron core has a flat section, a corner section adjacent to the flat section, a lap zone in the flat section, and a bent portion in the corner section.
(B) The corner sections (the corner sections of each of two inner cores and one outer core) each have two bent portions, and the angle formed by the two bent portions is 55° or less.

The condition (A) is satisfied by adopting a technique for producing a transformer wound core generally called a unicore or duocore type. Specifically, the condition (A) is satisfied by, as already described, constructing a three-phase three-legged wound core in such a manner that two adjacent inner cores and one outer core enclosing the two inner cores are each provided with a flat section, a corner section adjacent to the flat section, a lap zone in the flat section, and a bent portion in the corner section. The wound core may be produced by a known method. More specifically, for example, a unicore producing machine manufactured by AEM Cores Pty Ltd. may be used. In this case, the machine that has been loaded with the design size shears and bends a steel sheet to the designed size, thereby giving worked steel sheets one by one, and the worked steel sheets are stacked together to form the wound core.

In the condition (B), the bent portion indicates a portion in the corner section where the steel sheet changes its winding direction as viewed from the side of the iron core (viewed from the side in relation to the direction in which the steel sheet is wound). The angle formed by two bent portions is defined as the smaller angle (the angle less than) 180° of the angles formed by the two bent portions in one corner section (see FIG. 12). The upper limit of the angle formed by two bent portions should be 55°. Although the lower limit is not specified for any characteristics reasons, two bent portions forming a small angle are so close to each other that it is difficult to ensure precision in the working of such two bent portions. Thus, the angle formed by the two bent portions at the corner section is desirably 20° or more.

As long as the requirements (A) and (B) are controlled within the ranges according to aspects of the present invention, conditions other than (A) and (B), such as the type of steel sheet joints, and the iron core size, are not particularly limited.

### <Grain-Oriented Electrical Steel Sheets Constituting Three-Phase Three-Legged Wound Cores (Inner Cores and Outer Core)>

As described above, it is necessary to satisfy the condition (C) below in order to achieve a three-phase three-legged transformer wound core with low iron loss. Furthermore, it is preferable to satisfy the condition (D) below. (C) The grain-oriented electrical steel sheet as the iron core material has a magnetic flux density B8 of 1.92 T or more and 1.98 T or less at a magnetic field strength H of 800 A/m.

The magnetic properties are measured by the Epstein test. The Epstein test is performed in a known manner, such as IEC standards or JIS standards. When it is difficult to evaluate the magnetic flux density B8 by the Epstein test, for example, in the case of a non-heat-resistant magnetic domain refined material, the results obtained with a single sheet tester (SST) may be used instead. In the wound core production, the selection of materials according to the suitable range of magnetic flux density B8 should be made based on the representative properties of the grain-oriented electrical steel sheet coils. Specifically, test samples are collected from the front and rear ends of the steel sheet coil and are subjected to the Epstein test to measure the magnetic flux density B8, and the results are averaged to give the representative properties. Alternatively, the materials may be selected based on the property values (the average value and the guaranteed value) of the steel sheets provided by the steel manufacturers. The magnetic flux density B8 is preferably 1.94 T or more. The magnetic flux density B8 is preferably 1.96 T or less.
(D) (Preferred condition) The grain-oriented electrical steel sheet as the iron core material has an iron loss deterioration rate under harmonic superposition of 1.35 or less as calculated from the following formula:

iron loss deterioration rate under harmonic superposition=(iron loss under harmonic superposition)/(iron loss without harmonic superposition).

The iron loss under harmonic superposition and the iron loss without harmonic superposition defined in the above formula are the iron loss (W/kg) measured at a frequency of 50 Hz and a maximum magnetization of 1.7 T using the same Epstein tester or the same single sheet tester, and the iron loss under harmonic superposition is the iron loss measured under conditions where the superposition ratio of third harmonic to fundamental harmonic at an excitation voltage is 40% and the phase difference is 60°. The harmonic is superimposed on the voltage applied to the primary winding wire. The harmonic may be superimposed on the voltage applied to the primary winding wire in any manner without limitation. For example, a voltage with harmonic superposed waveform may be generated with a waveform generator and may be amplified with a power amplifier to serve as the excitation voltage (the voltage applied to the primary winding wire). In the harmonic superposition conditions in accordance with aspects of the present invention, the superposition ratio of third harmonic to fundamental harmonic at the excitation voltage is 40% and the phase difference is 60°. That is, the voltage waveform under the harmonic superposition conditions in accordance with aspects of the present invention is created by superposing, on a 50-Hz sine wave as the fundamental harmonic, the third harmonic, namely, a 150-Hz sine wave with 40% amplitude of the fundamental harmonic amplitude and a delay (a phase difference) of 60°. In accordance with aspects of the present invention, as described above, it is preferable that the grain-oriented electrical steel sheet used as the iron core material have an iron loss deterioration rate under harmonic superposition of 1.35 or less. The iron loss deterioration rate under harmonic superposition is more preferably 1.15 or less. The lower limit of the iron loss deterioration rate under harmonic superposition is not particularly limited. As an example, the iron loss deterioration rate under harmonic superposition is 1.00 or more.

As long as the requirement (C) is controlled to the range according to aspects of the present invention, conditions other than (C), such as characteristics, components, and production method, of the grain-oriented electrical steel sheet are not particularly limited.

In accordance with aspects of the present invention, the control of the requirements (A) to (C) to the ranges according to aspects of the present invention allows a three-phase three-legged wound core to attain excellent magnetic properties with low transformer iron loss without using two or more kinds of materials having different magnetic properties. Thus, aspects of the present invention can reduce the complexity encountered when designing iron cores using two or more kinds of iron core materials having different magnetic properties, for example, the arrangement of such materials, and enables high productivity of three-phase three-legged wound cores having excellent magnetic properties with low iron loss.

Components and a method of production of a grain-oriented electrical steel sheet suited as the material for the three-phase three-legged wound core according to aspects of the present invention will be described below.

### [Chemical Composition]

In accordance with aspects of the present invention, the chemical composition of a slab for grain-oriented electrical steel sheet may be any chemical composition as long as secondary recrystallization occurs. An inhibitor may be used. When, for example, an AlN inhibitor is used, appropriate amounts of Al and N may be added. When a MnS. MnSe inhibitor is used, appropriate amounts of Mn and Se and/or S may be added. It is needless to mention that both inhibitors may be used in combination. In such a case, the Al, N, S, and Se contents are preferably Al: 0.010 to 0.065 mass %, N: 0.0050 to 0.0120 mass %, S: 0.005 to 0.030 mass %, and Se: 0.005 to 0.030 mass %.

Aspects of the present invention may also be applied to an inhibitor-free grain-oriented electrical steel sheet in which the Al, N, S, and Se contents are limited. In this case, the amounts of Al, N, S, and Se are preferably controlled to Al: 100 ppm by mass or less, N: 50 ppm by mass or less, S: 50 ppm by mass or less, and Se: 50 ppm by mass or less.

The basic components and optional components of the slab for grain-oriented electrical steel sheet are described in detail below.

### C: 0.08 Mass % or Less

Carbon is added to improve the microstructure of the hot-rolled sheet. If, however, the C content is more than 0.08 mass %, it is difficult to decarburize the steel to a level of 50 ppm by mass or less where magnetic aging does not occur, before the completion of the production process. Thus, the C content is preferably 0.08 mass % or less. The C content has no particular lower limit because secondary recrystallization can occur even in a material containing no carbon. That is, the C content may be 0 mass %.

### Si: 2.0 to 8.0 Mass %

Silicon is an element effective in increasing the electrical resistance of steel and improving the iron loss. When the Si content is 2.0 mass % or more, the iron loss lowering effects are enhanced. When, on the other hand, the Si content is 8.0 mass % or less, the decrease in workability can be controlled easily and the decrease in magnetic flux density can also be controlled easily. Thus, the Si content is preferably in the range of 2.0 to 8.0 mass %.

### Mn: 0.005 to 1.000 Mass %

Manganese is an element necessary to improve hot workability. The addition produces its effect easily when the Mn content is 0.005 mass % or more. When, on the other hand, the Mn content is 1.000 mass % or less, the decrease in magnetic flux density of product sheets can be controlled easily. Thus, the Mn content is preferably in the range of 0.005 to 1.000 mass %.

### Cr: 0.02 to 0.20 Mass %

Chromium is an element that promotes the formation of a dense oxide film at the interface between a forsterite film and the steel substrate. Although an oxide film can form even in the absence of chromium, for example, the addition of 0.02 mass % or more chromium is expected to expand the preferred ranges of other components. When the Cr content is 0.20 mass % or less, an excessive increase in oxide film thickness can be prevented and the coating will be more resistant to separation. Thus, the Cr content is preferably in the range of 0.02 to 0.20 mass %.

The slab for grain-oriented electrical steel sheet preferably has the components described above as the basic components. In addition to the basic components, the slab may appropriately contain the following elements.

At least one selected from Ni: 0.03 to 1.50 mass %, Sn: 0.010 to 1.500 mass %, Sb: 0.005 to 1.500 mass %, Cu: 0.02 to 0.20 mass %, P: 0.03 to 0.50 mass %, and Mo: 0.005 to 0.100 mass %

Nickel is an element that is useful for improving the microstructure of the hot-rolled sheet and enhancing magnetic properties. When the Ni content is 0.03 mass % or more, magnetic properties are enhanced more effectively. When the Ni content is 1.50 mass % or less, the destabilization of secondary recrystallization can be suppressed and the risk will be reduced of the magnetic properties of product sheets being deteriorated. Thus, when nickel is added, the Ni content is preferably in the range of 0.03 to 1.50 mass %.

Tin, antimony, copper, phosphorus, and molybdenum are elements useful for enhancing magnetic properties, and offer effective enhancements in magnetic properties more easily when added at or above the lower limit contents of the respective elements. On the other hand, these elements added at or below the upper limit contents will not increase the risk that the development of secondary recrystallized grains will be inhibited. Thus, when tin, antimony, copper, phosphorus, and molybdenum are added, the contents of the respective elements are preferably within the ranges described above.

The balance after the above components is incidental impurities mixed during the production process and iron.

Next, a method for producing a grain-oriented electrical steel sheet suited as the material for the three-phase three-legged wound core according to aspects of the present invention will be described.

### [Heating]

A slab with the chemical composition described above is heated in a usual manner. The heating temperature is preferably 1150 to 1450° C.

### [Hot Rolling]

The heating is followed by hot rolling. Hot rolling may be performed directly after casting without heating. Hot rolling may be performed or omitted for a thin cast steel. When hot rolling is performed, the rolling temperature in the final rough rolling pass is preferably 900° C. or above, and the rolling temperature in the final finish rolling pass is preferably 700° C. or above.

### [Annealing of Hot-Rolled Sheet]

Subsequently, the hot-rolled sheet is annealed as required. In order to highly develop the Goss texture in the product sheet, the annealing temperature for the hot-rolled sheet is preferably in the range of 800 to 1100° C. If the annealing temperature for the hot-rolled sheet is below 800° C., the band texture formed in the hot rolling remains to make it difficult to realize a primary recrystallization texture with a controlled grain size, thus causing a risk that the development of secondary recrystallized grains will be inhibited. If, on the other hand, the annealing temperature for the hot-rolled sheet is above 1100° C., the grains after the hot-rolled sheet annealing are so coarsened that it may be difficult to realize a primary recrystallization texture with a controlled grain size.

### [Cold Rolling]

Subsequently, cold rolling is performed once, or two or more times with intermediate annealing. The intermediate annealing temperature is preferably 800° C. or above and 1150° C. or below. The intermediate annealing time is preferably about 10 to 100 seconds.

### [Decarburization Annealing]

Subsequently, decarburization annealing is performed. In the decarburization annealing, the annealing temperature is preferably 750 to 900° C., the oxidizing atmosphere PH₂O/PH₂ is preferably 0.25 to 0.60, and the annealing time is preferably about 50 to 300 seconds.

### [Application of Annealing Separator]

Subsequently, an annealing separator is applied. The annealing separator is preferably one based on MgO and the amount of application is preferably about 8 to 15 g/m².

### [Finish Annealing]

Subsequently, finish annealing is performed for the purposes of secondary recrystallization and forming a forsterite film. The annealing temperature is preferably 1100° C. or above, and the annealing time is preferably 30 minutes or more.

### [Flattening Treatment and Insulating Coating]

Subsequently, flattening treatment (flattening annealing) and insulating coating treatment are performed. The shape may be corrected concurrently in the insulating coating treatment by flattening the steel by the baking of the insulating coating that has been applied. The flattening annealing is preferably performed at an annealing temperature of 750 to 950° C. for an annealing time of about 10 to 200 seconds. In accordance with aspects of the present invention, the insulating coating may be applied to the surface of the steel sheet before or after the flattening annealing. Here, the insulating coating is a coating that applies a tension to the steel sheet (a tension coating) in order to reduce the iron loss. For example, the tension coating may be an inorganic coating containing silica, or a ceramic coating by physical vapor deposition, chemical vapor deposition, or the like.

In general, the iron loss deterioration rate under harmonic superposition decreases with increasing tension force on the steel sheet applied by the surface film (the forsterite film and the insulating coating). While the film tension can be increased by increasing the thickness of the tension coating, the space factor may be deteriorated. In the case of an inorganic coating containing silica, for example, the baking temperature may be increased and thereby glass crystallization may be promoted in order to obtain high tension without deteriorating the space factor. High tension is effectively obtained also by the application of a film with a low thermal expansion coefficient, such as a ceramic coating.

### [Magnetic Domain Refining Treatment]

To reduce the iron loss of the steel sheet, magnetic domain refining treatment is preferably performed. The magnetic domain refining technique reduces the iron loss by subdividing the width of magnetic domains through the physical introduction of nonuniformity to the surface of the steel sheet. The magnetic domain refining technique is broadly classified into heat-resistant magnetic domain refinement that does not lose the effect upon strain relief annealing, and non-heat-resistant magnetic domain refinement that loses the effect upon strain relief annealing. Aspects of the present invention may be applied to any of steel sheets without magnetic domain refining treatment, steel sheets with heat-resistant magnetic domain refining treatment, and steel sheets with non-heat-resistant magnetic domain refining treatment.

In particular, aspects of the present invention are suitably applied to a steel sheet with non-heat-resistant magnetic domain refining treatment rather than a steel sheet with heat-resistant magnetic domain refining treatment. The non-heat-resistant magnetic domain refining treatment is typically a treatment that divides magnetic domains into smaller domains by irradiating the steel sheet after secondary recrystallization with a high-energy beam (such as a laser beam) to introduce high-dislocation density regions into the steel sheet surface layer and thereby to form associated stress fields. In the non-heat-resistant magnetic domain refined material (the steel sheet with non-heat-resistant magnetic domain refining treatment), an increase in eddy-current loss by harmonic superposition can be avoided by virtue of the high tensile stress fields formed by the introduction of high-dislocation density regions into the steel sheet uppermost layer. The non-heat-resistant magnetic domain refining treatment may be performed by a known technique, such as applying a high-energy beam (such as a laser beam, an electron beam, or plasma jet) to the steel sheet surface.

### EXAMPLES

Aspects of the present invention will be described in detail based on Examples. The following Examples are only illustrative of preferred modes of the present invention and do not in any way limit the scope of the present invention. The embodiments of the present invention may be modified appropriately within the scope of the gist of the present invention, and all such modifications are included in the technical scope of the present invention.

### Example 1

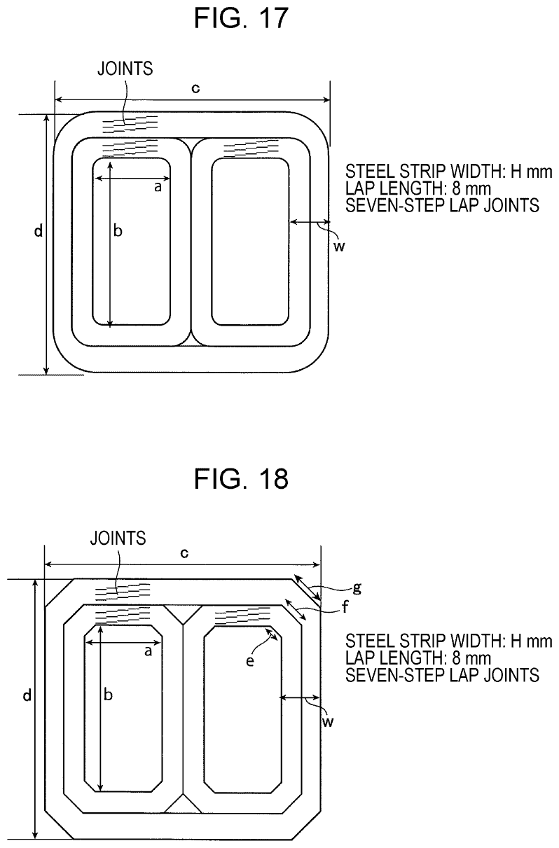

Three-phase three-legged tranco-cores and unicores with the iron core shapes described in FIG. 17 and Table 4 and in FIG. 18 and Table 5 were produced from iron core materials described in Table 6. Under conditions 1 to 12, the formed steel sheets were strain-relief annealed at 800° C. for 2 hours. Under conditions 13 to 50, strain relief annealing was not performed. The iron cores were then unwound from the joints, and 50-turn winding wire coils were inserted. The transformer iron loss was measured at an excitation magnetic flux density (Bm) of 1.5 T and a frequency (f) of 60 Hz. The results of the Epstein test of the iron core materials under the same conditions (the results obtained with a single sheet tester when the material was a non-heat-resistant magnetic domain refined material) were taken as the material iron loss. The building factor BF of the transformer iron loss relative to the material iron loss was determined.

TABLE 4

| | Steel strip | | | | | |
|---|---|---|---|---|---|---|
| | width H | a | b | c | d | w |
| | (mm) | (mm) | (mm) | (mm) | (mm) | (mm) |
| Tranco-core A | 150 | 100 | 200 | 344 | 296 | 48 |
| Tranco-core B | 130 | 110 | 180 | 400 | 300 | 60 |
| Tranco-core C | 150 | 130 | 320 | 500 | 480 | 80 |

TABLE 5

| | Steel strip | | | | | | | | | Angle formed by |
|---|---|---|---|---|---|---|---|---|---|---|
| | width H | a | b | c | d | e | f | g | w | bent portions |
| | (mm) | (mm) | (mm) | (mm) | (mm) | (mm) | (mm) | (mm) | (mm) | (deg.) |
| Unicore A | 150 | 100 | 200 | 344 | 296 | 3 | 12 | 21 | 48 | 22 |
| Unicore B | 150 | 100 | 200 | 344 | 296 | 4 | 15 | 26 | 48 | 26 |
| Unicore C | 150 | 100 | 200 | 344 | 296 | 4 | 16 | 28 | 48 | 29 |
| Unicore D | 150 | 100 | 200 | 344 | 296 | 5 | 20 | 35 | 48 | 36 |
| Unicore E | 150 | 100 | 200 | 344 | 296 | 5 | 23 | 41 | 48 | 44 |
| Unicore F | 150 | 100 | 200 | 344 | 296 | 5 | 26 | 47 | 48 | 52 |
| Unicore G | 150 | 100 | 200 | 344 | 296 | 5 | 28 | 51 | 48 | 57 |
| Unicore H | 150 | 100 | 200 | 344 | 296 | 5 | 30 | 55 | 48 | 63 |
| Unicore I | 150 | 100 | 200 | 344 | 296 | 5 | 32 | 59 | 48 | 68 |
| Unicore J | 130 | 110 | 180 | 400 | 300 | 4 | 27 | 50 | 60 | 45 |
| Unicore K | 150 | 130 | 320 | 500 | 480 | 4 | 38 | 72 | 80 | 50 |

The results are described in Table 6. It has been shown that superior magnetic properties were obtained in Examples and Optimum Examples of the present invention, with lower transformer iron loss and lower BF than Comparative Examples. In particular, Optimum Examples that involved a non-heat-resistant magnetic domain refined material with an iron loss deterioration rate under harmonic superposition of 1.35 or less attained very low transformer iron loss.

TABLE 6

| | | | | Iron core material (grain-oriented electrical steel sheet) | | | Excitation conditions | | | |
|---|---|---|---|---|---|---|---|---|---|---|
| | Three-phase three-legged wound core | | | | Iron loss | | Bm: 1.5 T, f: 60 Hz | | | |
| | | | Angle formed | Magnetic | deterioration | | Material | Trans- | | |
| | Strain | | by bent | flux | rate under | | iron | former iron | | |
| Condi- | relief | Iron core | portions | density | harmonic | Magnetic domain | loss | loss | | |
| tions | annealing | shape | (deg.) | B8 (T) | superposition | refining | (W/kg) | (W/kg) | BF | Remarks |
| 1 | Yes | Tranco- | — | 1.95 | 1.22 | No | 0.77 | 1.04 | 1.35 | Comp. |
| | | core A | | | | | | | | Ex. |
| 2 | | Tranco- | — | 1.90 | 1.15 | Heat-resistant magnetic | 0.70 | 1.02 | 1.45 | Comp. |
| | | core A | | | | domain refining | | | | Ex. |
| 3 | | Tranco- | — | 1.94 | 1.20 | No | 0.79 | 1.07 | 1.36 | Comp. |
| | | core B | | | | | | | | Ex. |
| 4 | | Tranco- | — | 1.90 | 1.16 | Heat-resistant magnetic | 0.69 | 0.98 | 1.42 | Comp. |
| | | core B | | | | domain refining | | | | Ex. |
| 5 | | Tranco- | — | 1.92 | 1.23 | No | 0.81 | 1.09 | 1.35 | Comp. |
| | | core C | | | | | | | | Ex. |
| 6 | | Tranco- | — | 1.88 | 1.13 | Heat-resistant magnetic | 0.75 | 1.10 | 1.47 | Comp. |
| | | core C | | | | domain refining | | | | Ex. |
| 7 | | Unicore E | 44 | 1.96 | 1.22 | No | 0.81 | 0.92 | 1.14 | Ex. |
| 8 | | Unicore E | 44 | 1.92 | 1.14 | Heat-resistant magnetic | 0.70 | 0.81 | 1.16 | Ex. |
| | | | | | | domain refining | | | | |
| 9 | | Unicore F | 52 | 1.94 | 1.21 | Nc | 0.79 | 0.90 | 1.14 | Ex. |
| 10 | | Unicore F | 52 | 1.90 | 1.12 | Heat-resistant magnetic | 0.70 | 0.97 | 1.39 | Comp. |
| | | | | | | domain refining | | | | Ex. |
| 11 | | Unicore G | 57 | 1.92 | 1.22 | No | 0.81 | 1.12 | 1.38 | Comp. |
| | | | | | | | | | | Ex. |
| 12 | | Unicore G | 57 | 1.88 | 1.13 | Heat-resistant magnetic | 0.73 | 1.02 | 1.40 | Comp. |
| | | | | | | domain refining | | | | Ex. |
| 13 | No | Unicore A | 22 | 1.94 | 1.20 | No | 0.79 | 0.88 | 1.12 | Ex. |
| 14 | | Unicore B | 26 | 1.94 | 1.20 | No | 0.79 | 0.88 | 1.12 | Ex. |
| 15 | | Unicore C | 29 | 1.94 | 1.20 | No | 0.79 | 0.89 | 1.13 | Ex. |
| 16 | | Unicore D | 36 | 1.94 | 1.20 | No | 0.79 | 0.89 | 1.13 | Ex. |
| 17 | | Unicore E | 44 | 1.94 | 1.20 | No | 0.79 | 0.89 | 1.13 | Ex. |
| 18 | | Unicore F | 52 | 1.94 | 1.20 | No | 0.79 | 0.90 | 1.14 | Ex. |
| 19 | | Unicore G | 57 | 1.94 | 1.20 | No | 0.79 | 1.00 | 1.26 | Comp. |
| | | | | | | | | | | Ex. |
| 20 | | Unicore H | 63 | 1.94 | 1.20 | No | 0.79 | 1.03 | 1.31 | Comp. |
| | | | | | | | | | | Ex. |
| 21 | | Unicore I | 68 | 1.94 | 1.20 | No | 0.79 | 1.06 | 1.34 | Comp. |
| | | | | | | | | | | Ex. |
| 22 | | Unicore E | 44 | 1.95 | 1.29 | No | 0.81 | 0.88 | 1.09 | Ex. |
| 23 | | Unicore E | 44 | 1.95 | 1.33 | No | 0.82 | 0.90 | 1.10 | Ex. |
| 24 | | Unicore E | 44 | 1.95 | 1.37 | No | 0.83 | 0.95 | 1.14 | Ex. |
| 25 | | Unicore E | 44 | 1.95 | 1.41 | No | 0.83 | 0.95 | 1.15 | Ex. |
| 26 | | Unicore E | 44 | 1.91 | 1.21 | No | 0.83 | 1.12 | 1.35 | Comp. |
| | | | | | | | | | | Ex. |
| 27 | | Unicore E | 44 | 1.92 | 1.22 | No | 0.81 | 0.93 | 1.15 | Ex. |
| 28 | | Unicore E | 44 | 1.93 | 1.22 | No | 0.80 | 0.93 | 1.16 | Ex. |
| 29 | | Unicore E | 44 | 1.95 | 1.22 | No | 0.80 | 0.93 | 1.16 | Ex. |
| 30 | | Unicore E | 44 | 1.97 | 1.22 | No | 0.79 | 0.92 | 1.17 | Ex. |
| 31 | | Unicore E | 44 | 1.99 | 1.23 | No | 0.77 | 1.02 | 1.32 | Comp. |
| | | | | | | | | | | Ex. |
| 32 | | Unicore D | 36 | 1.93 | 1.14 | Non-heat-resistant magnetic | 0.69 | 0.72 | 1.04 | Opt. Ex. |
| | | | | | | domain refining | | | | |
| 33 | | Unicore E | 44 | 1.93 | 1.14 | Non-heat-resistant magnetic | 0.69 | 0.72 | 1.05 | Opt. Ex. |
| | | | | | | domain refining | | | | |
| 34 | | Unicore F | 52 | 1.93 | 1.14 | Non-heat-resistant magnetic | 0.69 | 0.72 | 1.05 | Opt. Ex. |
| | | | | | | domain refining | | | | |
| 35 | | Unicore G | 57 | 1.93 | 1.14 | Non-heat-resistant magnetic | 0.69 | 0.86 | 1.25 | Comp. |
| | | | | | | domain refining | | | | Ex. |
| 36 | | Unicore H | 63 | 1.93 | 1.14 | Non-heat-resistant magnetic | 0.69 | 0.87 | 1.26 | Comp. |
| | | | | | | domain refining | | | | Ex. |
| 37 | | Unicore J | 45 | 1.90 | 1.23 | No | 0.84 | 1.11 | 1.32 | Comp. |
| | | | | | | | | | | Ex. |
| 38 | | Unicore J | 45 | 1.94 | 1.25 | No | 0.79 | 0.88 | 1.12 | Ex. |
| 39 | | Unicore J | 45 | 1.96 | 1.25 | No | 0.78 | 0.88 | 1.13 | Ex. |
| 40 | | Unicore J | 45 | 1.96 | 1.37 | No | 0.81 | 0.94 | 1.16 | Ex. |
| 41 | | Unicore J | 45 | 1.94 | 1.10 | Non-heat-resistant magnetic | 0.67 | 0.72 | 1.07 | Opt. Ex. |
| | | | | | | domain refining | | | | |
| 42 | | Unicore J | 45 | 1.96 | 1.09 | Non-heat-resistant magnetic | 0.64 | 0.68 | 1.07 | Opt. Ex. |
| | | | | | | domain refining | | | | |
| 43 | | Unicore J | 45 | 1.96 | 1.06 | Non-heat-resistant magnetic | 0.64 | 0.68 | 1.06 | Opt. Ex. |
| | | | | | | domain refining | | | | |
| 44 | | Unicore J | 45 | 1.94 | 1.20 | No | 0.79 | 0.84 | 1.06 | Ex. |
| 45 | | Unicore K | 50 | 1.91 | 1.05 | Non-heat-resistant magnetic | 0.74 | 0.98 | 1.32 | Comp. |
| | | | | | | domain refining | | | | Ex. |
| 46 | | Unicore K | 50 | 1.93 | 1.09 | Non-heat-resistant magnetic | 0.68 | 0.74 | 1.09 | Opt. Ex. |
| | | | | | | domain refining | | | | |
| 47 | | Unicore K | 50 | 1.97 | 1.11 | Non-heat-resistant magnetic | 0.63 | 0.67 | 1.07 | Opt. Ex. |
| | | | | | | domain refining | | | | |
| 48 | | Unicore K | 50 | 1.99 | 1.28 | No | 0.77 | 1.01 | 1.31 | Comp. |
| | | | | | | | | | | Ex. |
| 49 | | Unicore K | 50 | 1.96 | 1.21 | No | 0.78 | 0.90 | 1.16 | Ex. |
| 50 | | Unicore K | 50 | 1.92 | 1.22 | No | 0.81 | 0.95 | 1.17 | Ex. |

*Underlines indicate being outside the range of the present invention.

1. A three-phase three-legged wound core comprising two adjacent inner cores and one outer core enclosing the two inner cores, the inner cores and the outer core comprising a grain-oriented electrical steel sheet, wherein
the two inner cores and the one outer core each have a flat section, a corner section adjacent to the flat section, a lap zone in the flat section, and a bent portion in the corner section,
the corner sections of the two inner cores and of the one outer core are each provided with two bent portions, the angle formed by the two bent portions being 55° or less, and
the grain-oriented electrical steel sheet has a magnetic flux density B8 of 1.92 T or more and 1.98 T or less at a magnetic field strength H of 800 A/m.

2. The three-phase three-legged wound core according to claim 1, wherein the grain-oriented electrical steel sheet has an iron loss deterioration rate under harmonic superposition of 1.35 or less as determined from the following formula:
iron loss deterioration rate under harmonic superposition=(iron loss under harmonic superposition)/(iron loss without harmonic superposition)
wherein the iron loss under harmonic superposition and the iron loss without harmonic superposition are each an iron loss (W/kg) measured at a frequency of 50 Hz and a maximum magnetization of 1.7 T, and the iron loss under harmonic superposition is an iron loss measured under conditions where the superposition ratio of third harmonic to fundamental harmonic at an excitation voltage is 40% and the phase difference is 60°.

3. The three-phase three-legged wound core according to claim 1, wherein the grain-oriented electrical steel sheet has been subjected to non-heat-resistant magnetic domain refining treatment.

4. The three-phase three-legged wound core according to claim 2, wherein the grain-oriented electrical steel sheet has been subjected to non-heat-resistant magnetic domain refining treatment.

5. A method for producing a three-phase three-legged wound core, the three-phase three-legged wound core being such that the three-phase three-legged wound core comprises two adjacent inner cores and one outer core enclosing the two inner cores; the inner cores and the outer core comprise a grain-oriented electrical steel sheet; and the two inner cores and the one outer core each have a flat section, a corner section adjacent to the flat section, a lap zone in the flat section, and a bent portion in the corner section, the method comprising:
providing each of the corner sections of the two inner cores and of the one outer core with two bent portions in such a manner that the angle formed by the two bent portions is 55° or less,
the grain-oriented electrical steel sheet having a magnetic flux density B8 of 1.92 T or more and 1.98 T or less at a magnetic field strength H of 800 A/m.

6. The method for producing a three-phase three-legged wound core according to claim 5, wherein the grain-oriented electrical steel sheet has an iron loss deterioration rate under harmonic superposition of 1.35 or less as determined from the following formula:
iron loss deterioration rate under harmonic superposition=(iron loss under harmonic superposition)/(iron loss without harmonic superposition)
wherein the iron loss under harmonic superposition and the iron loss without harmonic superposition are each an iron loss (W/kg) measured at a frequency of 50 Hz and a maximum magnetization of 1.7 T, and the iron loss under harmonic superposition is an iron loss measured under conditions where the superposition ratio of third harmonic to fundamental harmonic at an excitation voltage is 40% and the phase difference is 60°.

7. The method for producing a three-phase three-legged wound core according to claim 5, wherein the grain-oriented electrical steel sheet has been subjected to non-heat-resistant magnetic domain refining treatment.

8. The method for producing a three-phase three-legged wound core according to claim 6, wherein the grain-oriented electrical steel sheet has been subjected to non-heat-resistant magnetic domain refining treatment.
